(19) United States
(12) Patent Application Publication
(10) Pub. No.: US 2009/0164230 A1
(43) Pub. Date: Jun. 25, 2009

(54) Method for transporting checked airline passenger baggage with enhanced security and efficiency

(76) Inventor: Anthony N. Pera, Coral Springs, FL (US)

Correspondence Address: Russ Weinzimmer, 614 Nashua Street, Suite 53, Milford, NH, 03055, US

(21) Appl. No.: 12/004,602

(22) Filed: Dec. 22, 2007

(51) Int. Cl. G06Q 50/00

(52) U.S. Cl. 705/1

(57) ABSTRACT

An airline baggage system is disclosed that improves security, efficiency, and comfort and saves cost on commercial passenger flights by transporting all checked baggage on a separate vehicle, not on the aircraft carrying the passengers, the separate vehicle being supplied and operated by entities at least affiliated with the airline. The baggage vehicle can be an aircraft, a truck, a train, etc, and can simultaneously carry baggage from a plurality of flights. A baggage delivery service can transport baggage to and from airports, and baggage handlers can accept baggage dropped off and/or deliver baggage picked up at airports. In some embodiments, checked baggage is delivered at least one hour before passenger arrival. In embodiments where checked baggage transportation requires more time than the passenger flight, for example two days, baggage can be checked before departure and picked up upon arrival, or checked upon departure and picked up after arrival.

### FIELD OF THE INVENTION

This invention relates generally to airline baggage handling, and more particularly to methods for transporting baggage checked by airline passengers with improved security and efficiency.

### BACKGROUND OF THE INVENTION

Recently, and most notably since the Sep. 11, 2001 hijackings and terrorist attacks, security has become a growing concern at airports around the world. Security measures at major airports have increased in a variety of ways. The number of security checkpoints and personnel at these airports has grown, and all airline passengers are being thoroughly inspected, along with their carry-on baggage, before boarding their flights. These precautions acts as both protections and deterrents against possible hijacker or terrorist activity, and they also maintain the awareness and increase the vigilance of passengers.

While security checks for passengers and carry-on baggage have become increasingly thorough, screening of checked baggage has not been as thoroughly addressed or as universally applied. Yet checked baggage represents a significant threat to the safety and security of airline flights, since a remotely activated or timed explosive or other disruptive device can be hidden in checked baggage. Individuals wishing to disrupt a flight may be able to check baggage containing a disruptive device without actually boarding the flight, or they may be willing to board the flight and become martyrs so as to ensure successful activation of the checked device.

Some airports have attempted to reduce the security threat of checked baggage by implementing checked baggage X-Ray screening and/or random searches and other security measures. However, some of these security measures, such as random searches, offer only limited protection and deterrence, and none of them is universally applied. It would be possible to pass laws and/or implement universal policies that would provide for uniform screening of all checked airline baggage, similar to what is currently applied to carry-on luggage. However, the cost of doing so would be prohibitive.

In addition to security risks, checked airline baggage also adds significantly to the weight of a commercial aircraft flight, leading to significantly higher fuel consumption, increased emission of greenhouse gasses, increased dependence on foreign oil, and higher cost to airlines and to passengers. Also, last minute loading of checked baggage can lead to delays in flight departures, and slow unloading of checked baggage frequently leads to delays and inconvenience experienced by passengers waiting for baggage delivery after arrival.

Finally, when travel plans are changed at the last minute, due for example to mechanical failure, missed flights, or opportunities to take earlier flights, checked baggage can lead to baggage transfer complications and delayed or lost baggage.

### SUMMARY

The present invention is an improved system for transportation of baggage checked by commercial airline passengers, wherein the checked baggage is transported by one or more baggage carriers such as cargo aircraft or trucks that are separate from the aircraft that carries the passengers. The system is uniformly applied to all passengers on a given flight, thereby overcoming the potential security threat related to checked flight baggage because none of the checked baggage travels on the same flight as the passengers that checked the baggage. Flight delays due to slow baggage loading are also eliminated because the baggage does not travel with the airline flight. In preferred embodiments, inconvenience and delays in waiting for baggage delivery after arrival of the flight are eliminated because the checked baggage either arrives before the flight or is picked up at a later time. In some preferred embodiments, checked baggage from a plurality of flights is consolidated and transported on fuel efficient cargo plans and/or on trucks, trains, and other surface cargo carriers. This removes a significant amount of weight from airline flights and thereby reduces airline fuel consumption, fuel cost, and greenhouse gas emissions.

In the present invention, checked baggage is transported by baggage transport services that are either subsidiaries of airlines or at least directly affiliated with the airlines that they serve. Therefore, even though a separate transportation system handles checked baggage, the responsibility and accountability to the traveling passengers remains with the airlines. Additionally, preferred embodiments of the present invention include the option for a private service to transport checked passenger baggage to the airport before a departure and/or from the airport after an arrival.

In preferred embodiments, the present invention allows for a baggage travel time that is either variable or fixed. In some embodiments, the fixed baggage travel time is two days. Allowing for a variable or fixed baggage travel time enables consolidation of baggage from multiple flights and/or surface transportation of the checked baggage. For example, in preferred embodiments where the fixed baggage travel time is two days, passengers are given the option of either checking their baggage two days prior to departure, or retrieving their checked baggage two days after arrival. In these preferred embodiments, passengers traveling between their homes and remote destinations will typically choose to check their baggage two days before departing from their home areas, and to pick up their baggage two days after returning to their home areas, since in most cases there will be only minimal inconvenience associated with early checking and late retrieval of baggage when a passenger is at home.

In further preferred embodiments, baggage that is checked before a flight departure or retrieved after a flight arrival can be brought to the airport or picked up from the airport by the passenger, or can be brought to the airport or picked up from the airport by a private service.

### BRIEF DESCRIPTION OF THE DRAWINGS

The invention will be more fully understood from the following detailed description, in conjunction with the accompanying figures, wherein:

FIG. 1A illustrates the handling of a passenger's baggage during a trip from home to a remote location in a preferred embodiment;

FIG. 1B illustrates the handling of a passenger's baggage during a trip home from a remote location in a preferred embodiment;

FIG. 2 illustrates a passenger's trip from home to a remote location and the handling of the passengers checked baggage in a preferred embodiment;

FIG. 3 illustrates a passenger's return trip home from a remote location in a preferred embodiment;

FIG. 4 is a flow diagram of a trip of a passenger from home to a remote location, and of the handling of the passenger's checked baggage, in a preferred embodiment; and

FIG. 5 is a flow diagram of a return trip home of a passenger from a remote location, and the handling of the passenger's baggage, in a preferred embodiment.

### DETAILED DESCRIPTION OF THE INVENTION

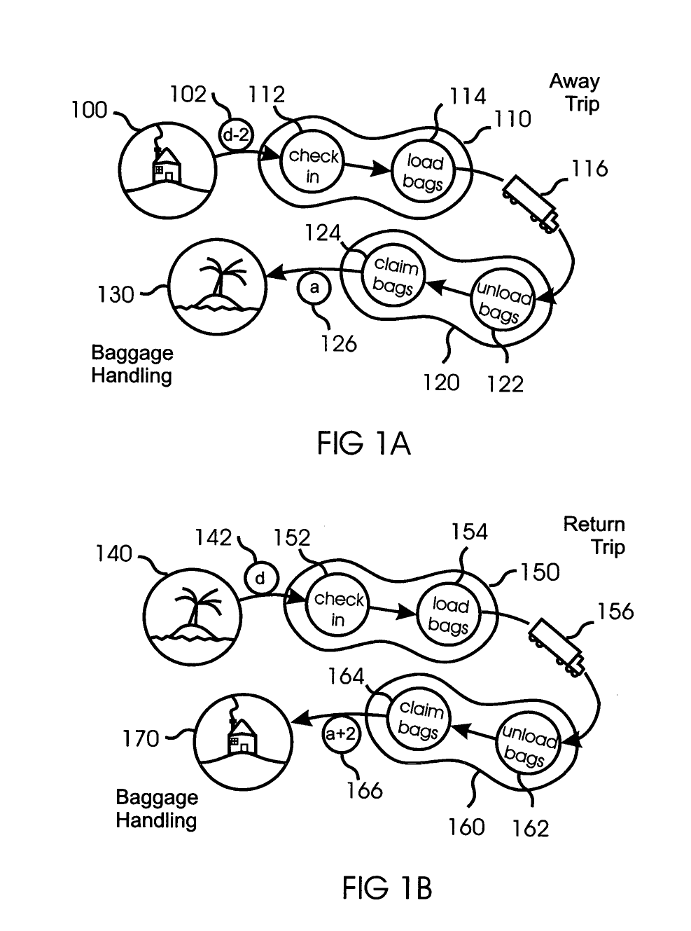

FIG. 1A and FIG. 1B illustrate the handling of an airline passenger's checked baggage in a preferred embodiment that allows for a fixed baggage travel time of two days. FIG. 1A depicts the handling of checked baggage during a trip from a home area location 100, such as a home or office, to a remote destination location 130, such as a vacation resort or a remote business meeting site. As shown in FIG. 1A, the checked baggage begins its journey at the home area location 100. The baggage is brought to the home area airport 110, where it is received and checked in at the check-in terminal 112 two days before the actual departure 102 of the flight. After check-in 112, the baggage is loaded onto a separate cargo carrier 116, such as a truck, as shown in FIG. 1A, or on a train, a separate cargo aircraft, or another separate baggage carrying vehicle that is operated by the airline, a subsidiary of the airline, or some other entity that is at least affiliated with the airline. In some embodiments, the checked baggage is consolidated with checked baggage from other flights traveling to the same destination. Baggage carrying vehicles can also pick up and drop off checked baggage at multiple airports so as to increase efficiency and reduce costs.

The checked baggage is transported by the separate cargo carrier 116 to the remote destination airport 120, where the baggage is unloaded at an unloading site 122. The baggage is then deposited at a baggage claim terminal 124, where it is ready and waiting when the passengers deplane at their destination airport 120. The baggage is retrieved by the passengers or by a private transportation service and transported to its final destination 130 in the remote area.

FIG. 1B depicts the handling of baggage during a return trip from a remote destination location 140 to a home area location 170. The checked baggage begins its return journey at the remote destination location 140. The baggage is brought to the remote destination airport 150 by the passenger on the day of departure 142, where it is received and checked in at the check-in terminal 152 just before the flight. From check-in 152, the baggage is loaded 154 onto a separate cargo carrier 156, such as a truck, as shown in FIG. 1B, or on a train, a separate cargo aircraft, or another separate baggage carrying vehicle that is operated by the airline, a subsidiary of the airline, or some other entity that is at least affiliated with the airline. In some embodiments, the checked baggage is consolidated with checked baggage from other flights traveling to the same destination. Baggage carrying vehicles can also pick up and drop off checked baggage at multiple airports so as to increase efficiency and reduce costs.

The baggage is transported via the separate cargo carrier 156 to the home area airport 160, where the baggage is unloaded at an unloading site 162. The baggage is then deposited at a baggage claim terminal 164, where it is retrieved by the passenger or by a private service two days after the passenger's arrival 166, and transported to the passenger's home.

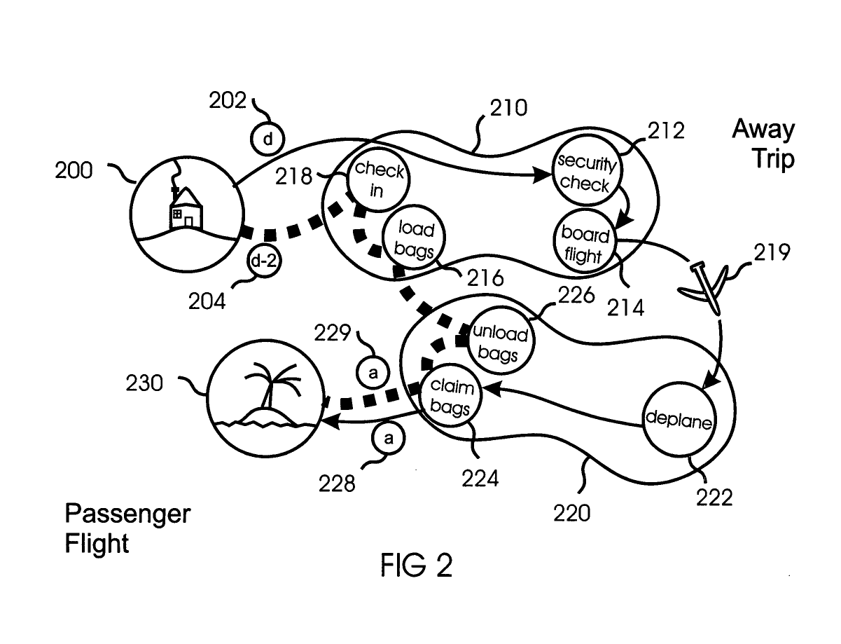

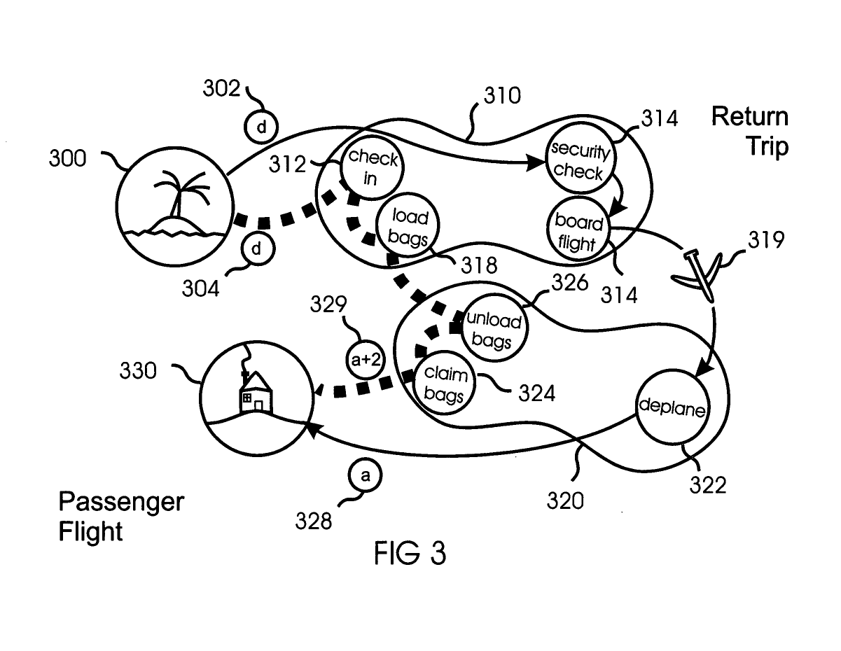

FIG. 2 and FIG. 3 illustrate the actions of a passenger in relationship to the handling of the passenger's checked baggage in the preferred embodiment of FIG. 1. FIG. 2 illustrates a trip from home 200 to a remote destination location 230, such as a vacation resort or a remote business meeting site. The baggage is brought to the airport 210 and checked in 218 two days prior to the departure 204 of the flight. When the passenger arrives at the airport 210 on the day of departure 202, the passenger can proceed directly to the security check 212.

Once the passenger clears security 212, the passenger can board the flight 214. Because the baggage has been loaded onto a separate cargo carrier, the passenger flight aircraft 219 is more secure, more spacious, and less heavy than traditional passenger flights. A delay in departure due to slow loading of checked passenger baggage is not possible, because the checked baggage does not travel on the same flight as the passenger. When the passenger deplanes 222 at the destination airport 220, the checked baggage has already been unloaded at an unloading site 226 and deposited at a baggage claim terminal 224 at the destination airport 220. When the passenger arrives 228, the baggage 229 has already been delivered and is waiting and ready to be retrieved and taken to the remote destination location 230.

FIG. 3 illustrates a return trip home 330 from a remote destination location 300. The checked baggage is brought to the check-in terminal 312 of the remote destination airport 310 on the same day 304 as the passenger's actual departure 302. Once the baggage is checked in, the passenger proceeds to the security check 314. and then boards the flight 316.

Because the baggage is loaded onto a separate cargo carrier, the passenger flight 319 is once again more secure, more spacious, and less heavy than traditional passenger flights. A delay in departure due to slow loading of checked passenger baggage is not possible, because the checked baggage does not travel on the same flight as the passenger. When the passenger deplanes 322 at the home area airport 320 on the day of the flight's arrival 328, the passenger can proceed directly home 220. Two days after the arrival of the flight 329, the baggage is unloaded at an unloading site 326, and deposited at a baggage claim terminal 324 where it is retrieved either by the passenger or by a private service and taken to the passenger's home.

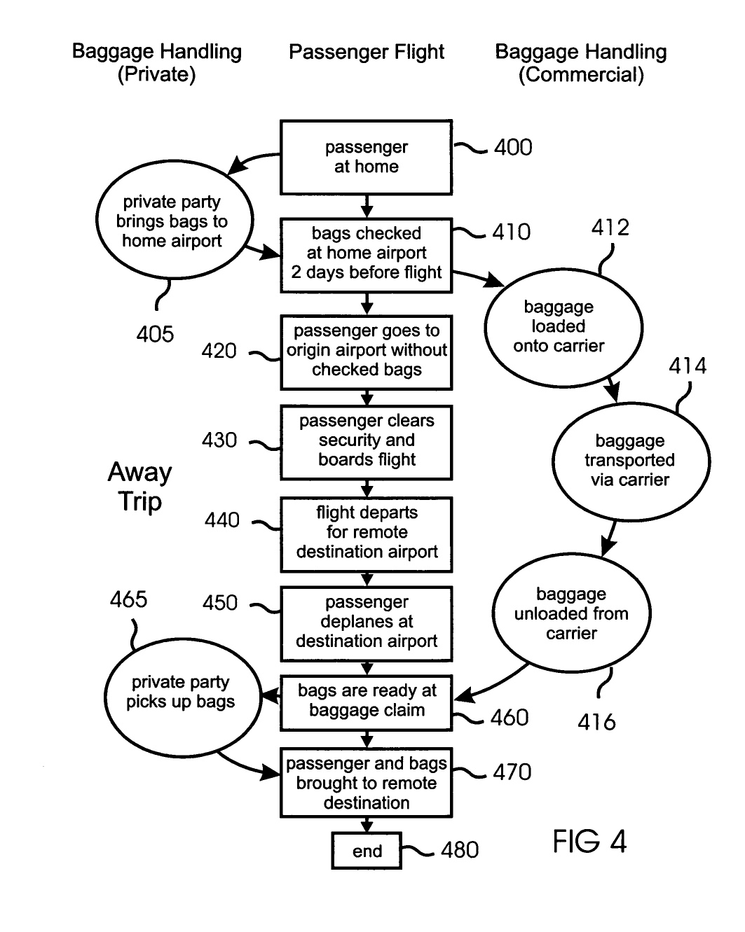

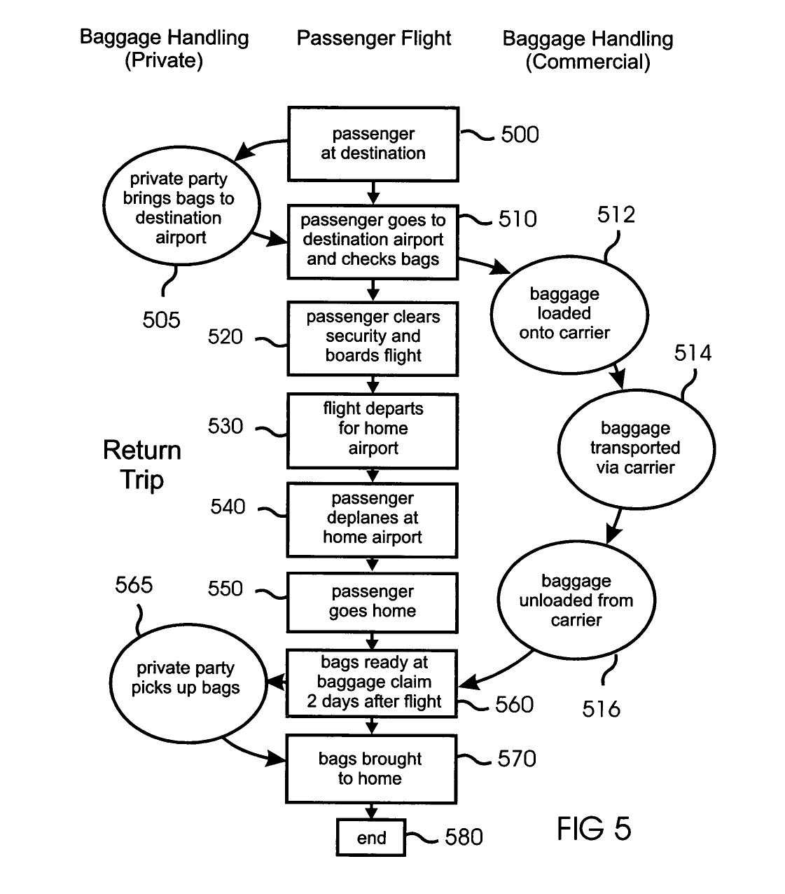

FIG. 4 and FIG. 5 are flow diagrams that illustrate the actions of a passenger in relationship to the handling of the passenger's checked baggage in the preferred embodiment of FIG. 1. FIG. 4 depicts a trip from home to a remote destination location, such as a vacation resort or a remote business meeting location. Two days prior to flight departure 410 the passenger or a private service such as Baggagecheckin.com or Luggageconcierge.com brings the passenger's baggage from the passenger's home 400 to the home area airport and checks it in 405. After check-in, the baggage is loaded onto a cargo carrier 412.

On the day of the flight, the passenger goes to the airport without the checked baggage 420, the passenger proceeds through security and boards the flight 430, and the flight departs for the destination airport 440. Before the passenger flight, the checked baggage has already been transported by a separate cargo carrier 414 and unloaded 416 at the destination airport. When the passenger deplanes at the destination airport 450, the baggage is ready at the baggage claim area 460. The passenger retrieves the checked baggage, and both the passenger and the baggage proceed to the remote destination location 470, arriving there at the same time 480.

FIG. 5 depicts a trip home from a remote destination location, such as a vacation resort or a remote business meeting location. On the day of the flight's departure, the passenger travels with bags from the remote destination location 500 to the remote area airport 505, and checks the bags in 510. After being checked-in, the baggage is loaded onto a cargo carrier 512.

After checking in the bags, the passenger proceeds through security and boards the flight 520. The flight departs for the home area airport 530, and upon arrival the passenger deplanes at the home area airport 540 and goes home 550. The checked baggage is transported by the cargo carrier from the remote area airport to the home area airport 514. Two days after the passenger's arrival home, the checked baggage is unloaded from the cargo carrier 516, and is brought to the baggage claim area 560 at the home area airport. The passenger or a private service such as Baggagecheckin.com or Luggageconcierge.com picks up 565 the checked baggage and brings it home 570. At this point, both the passenger and the baggage have reached their final destination 580.

Other modifications and implementations will occur to those skilled in the art without departing from the spirit and the scope of the invention as claimed. Accordingly, the above description is not intended to limit the invention except as indicated in the following claims.

What is claimed is:

1. A method for providing checked passenger baggage transportation for passengers traveling on an airline flight from an origin to a destination, the method comprising:
checking all passenger baggage at the origin that will not be carried in a passenger carrying cabin of the flight; and
transporting the checked baggage to the destination on a checked baggage transportation vehicle that is not transporting the flight passengers, the checked baggage transportation vehicle being provided and operated by entities that are at least affiliated with the airline.

2. The method of claim 1, wherein the checked baggage transportation vehicle is able to simultaneously transport checked baggage from a plurality of flights.

3. The method of claim 1, wherein the checked baggage transportation vehicle also transports checked baggage from locations other than the origin.

4. The method of claim 1, wherein the checked baggage transportation vehicle also transports checked baggage to locations other than the destination.

5. The method of claim 1, wherein the checked baggage transportation vehicle is at least one of provided and operated by a subsidiary of the airline.

6. The method of claim 1, wherein the checked baggage transportation vehicle is an aircraft.

7. The method of claim 1, wherein the checked baggage transportation vehicle is at least one of an automobile, a truck, a train, and other ground transportation vehicles.

8. The method of claim 1, wherein baggage is delivered to the origin by a baggage delivery service.

9. The method of claim 1, wherein checked baggage is retrieved from the destination by a baggage delivery service.

10. The method of claim 1, wherein baggage handlers are present at a drop-off point near the origin to receive baggage from at least one of passengers and baggage delivery service personnel, so as to deliver the baggage to be checked.

11. The method of claim 1, wherein baggage handlers are present at a baggage pick-up point near the destination to deliver checked baggage to at least one of passengers and baggage delivery service personnel.

12. The method of claim 1, wherein the checked baggage is delivered to the destination at least 1 hour before the flight is scheduled to arrive at the destination.

13. The method of claim 1, wherein a baggage transportation time interval is required for transportation of the checked baggage from the origin to the destination, the baggage transportation time interval being longer than a scheduled time interval for the flight to travel from the origin to the destination.

14. The method of claim 13, wherein passenger baggage can be checked at the origin sufficiently in advance of a scheduled departure of the airline flight to allow the checked baggage to be delivered to the destination no later than a scheduled arrival of the airline flight.

15. The method of claim 13, wherein baggage can be checked at the origin at essentially the same time as a scheduled departure of the airline flight and retrieved from the destination at a time sufficiently after a scheduled arrival of the airline flight to allow the baggage to arrive at the destination.

16. The method of claim 1, wherein a fixed baggage transportation time interval is allowed for transportation of checked baggage from the origin to the destination, the fixed baggage transportation time interval being the same for all flights to which the method of claim 1 is applied.

17. The method of claim 16, wherein the fixed baggage transportation time interval is 2 days.

18. The method of claim 16, wherein each passenger on the airline flight wishing to check baggage is required to choose one of two baggage checking options, the baggage checking options being:
checking baggage at least at the fixed baggage transportation time interval before a scheduled departure time of the flight and retrieving the checked baggage upon arrival at the destination; and
checking baggage essentially at the time of departure of the flight and retrieving the checked baggage at least the fixed baggage transportation time interval after a scheduled arrival time of the flight.
